(19) United States
(12) Patent Application Publication
(10) Pub. No.: US 2005/0138752 A1
(43) Pub. Date: Jun. 30, 2005

(54) Cylinder cleaning brush unit

(76) Inventor: Akira Hara, Tokyo (JP)

Correspondence Address: MORGAN & FINNEGAN, L.L.P., 3 World Financial Center, New York, NY, 10281-2101, US

(21) Appl. No.: 11/065,683

(22) Filed: Feb. 24, 2005

Related U.S. Application Data
(62) Division of application No. 10/131,773, filed on Apr. 23, 2002.

(30) Foreign Application Priority Data
Apr. 27, 2001 (JP) 2001-133566

(51) Int. Cl. B08B 1/00

(52) U.S. Cl. 15/256.52; 15/256.51

(57) ABSTRACT

There is disclosed a cylinder cleaning brush unit including a brush roller for cleaning a cylinder. The cylinder includes an outer surface to which impurities are adhered, the impurities being removed from the outer surface by the brush roller with cleaning liquid being supplied. The brush unit comprises an opening through which effluent is discharged from the brush unit, the effluent including the cleaning liquid and the impurities. The brush unit further comprises a filter installed in the opening, the effluent being filtrated by the filter.

### FIELD OF THE INVENTION

The invention relates to a cylinder cleaning brush unit including a brush roller for cleaning a cylinder in an offset printing press, paper making machine, paper converting machine, textile machinery or the like. The cylinder includes an outer surface to which impurities are adhered. The impurities are removed from the outer surface by the brush roller with cleaning liquid being supplied.

### Prior Art

For example, impurities such as ink and powdered paper are adhered to the outer surface of a cylinder in an offset printing press or other printing press. It is therefore required to clean the cylinder at intervals to keep each of printed products having a good quality.

Under the circumstances, there has heretofore been proposed a cylinder cleaning apparatus including a brush unit 2 which comprises a brush roller 4 for cleaning a cylinder 6, as shown in FIG. 27. The brush roller 4 is disposed between and mounted on side frames 8 for rotation to be brought into contact with the cylinder 6 at a contact position P, the brush roller 4 extending parallel to the cylinder 6. In addition, the brush roller 4 is connected to a drive such as a motor 10, as shown in FIG. 28, and rotated clockwise in FIG. 27 by the drive 10 to clean the cylinder 6 which is rotated counterclockwise in FIG. 27 at a speed different from the brush roller 4. The cylinder 6 includes an outer surface to which impurities are adhered, the impurities being removed from the outer surface by the brush roller 4 with cleaning liquid being supplied. The cleaning liquid may comprise solvent and water. For example, nozzles 12 are mounted on a cross frame 14 to spout the solvent and water which are directed to the brush roller 4 and the cylinder 6 by a cover plate 16 and a hood 18. The cross frame 14 is disposed between and mounted on the side frames 8 to extend longitudinally of the brush roller 4.

The apparatus is accompanied with effluent including the cleaning liquid and impurities and discharged from the brush unit 2. In this connection, a tray 20 is disposed beneath the brush unit 2 so that the effluent can be discharged from the brush unit 2 to be received in the tray 20. The tray 20 may include an outlet or drain port 22 formed in the bottom thereof, the effluent being discharged from the outlet port 22. In addition, the apparatus includes a flipper bar 24 supported by a stay 26 and brought into contact with the brush roller 4. The effluent is flipped from the brush roller 4 by the flipper bar 24. The stay 26 is disposed between and mounted on the side frames 8 to extend longitudinally of the brush roller 4.

However, in the apparatus in which the tray 20 does not include the outlet port 22, an operator has to detach and convey the tray 20 from the apparatus whenever the tray 20 is filled with the effluent to pour the effluent into a receptacle from the tray 20 without spilling the effluent. In addition, it is required to clean the tray 20 of sludge grown from the effluent. The operator is therefore forced to do dirty work taking labours and times. The work is very hard especially in the apparatus including many brush units.

On the other hand, as to the tray 20 which includes the outlet port 22, a drain pipe is generally connected to the outlet port 22 to drain the effluent into a receptacle from the tray 20 through the drain pipe. However, the drain pipe may be clogged with sludge grown from the effluent and adhered to and deposited on the inner surface of the drain pipe. In this case, the effluent can overflow the tray 20 due to lack of drainage. Accordingly, the operator is required to clean the drain pipe clogged with the sludge, taking labours and times. It may be required to exchange the drain pipe for new one.

Furthermore, the cross frame 14 is splashed with the effluent flipped from the brush roller 4 by the flipper bar 24 so that sludge can be grown from the effluent and adhered to and deposited on the cross frame 14. It is therefore required to clean the cross frame 14 of sludge.

It is therefore an object of the invention to provide a new and improved cylinder cleaning brush unit and cylinder cleaning apparatus, to thereby overcome the above problems.

Other object of the invention is to liberate an operator from dirty work taking labours and times for maintenance to improve efficiency, safety and productivity.

### SUMMARY OF THE INVENTION

According to the invention, there is provided a cylinder cleaning brush unit including a brush roller for cleaning a cylinder. The cylinder includes an outer surface to which impurities are adhered, the impurities being removed from the outer surface by the brush roller with cleaning liquid being supplied.

The brush unit comprises an opening through which effluent is discharged from the brush unit, the effluent including the cleaning liquid and the impurities. The brush unit further comprises a filter installed in the opening, the effluent being filtrated by the filter.

In a preferred embodiment, the brush roller is brought into contact with the cylinder at a constant position and rotated in a rotating direction to clean the cylinder.

The filter may be installed in the opening to extend to the vicinity of a tangent which extends tangentially to the brush roller and the cylinder at the contact position.

The filter may be made of a woven or nonwoven fabric, net or perforated film. The filter may comprise a sheet.

In the embodiment, the brush unit further comprises a cover frame disposed opposite to the cylinder with respect to the brush roller, the cover frame including a curved surface extending along the periphery of the brush roller, the brush roller being brought into contact with the curved surface in an angular range. The brush roller may be close to the curved surface in an angular range.

The filter may comprise a continuous web held by and fed from a holder. In this case, the brush unit may further comprise take up means for taking up the used filter.

In the embodiment, the brush unit further comprises a flipper bar disposed downstream of the contact position in the rotating direction and brought into contact with the brush roller, and adjustment means by which the flipper bar is moved for adjustment of position. The opening is formed downstream of the flipper bar in the rotating direction.

The filter may be received and supported by a receiver. The brush unit may further comprise detecting means for detecting the decrease or exhaustion of the filter held by the holder.

In the embodiment, the brush unit further comprises a stay extending longitudinally of the brush roller and mounted on side frames. The flipper bar is supported by the stay for movement. The stay includes the adjustment means mounted thereon.

The stay may have a reversed U-shaped channel or L-shaped angle cross section in which an inside space is formed, the adjustment means being accommodated in the inside space. The filter may be held by the holder to be accommodated in the inside space.

In the embodiment, the the brush roller and the cylinder are rotated downwardly at the contact position.

The take up means may include positioning means formed on a take up shaft for positioning the filter when attached to the take up shaft.

The cover frame may include an inclined surface extending downwardly from the lower edge of the curved surface to be inclined away from the cylinder with respect to a vertical plane. The curved surface and the inclined surface may be disposed downstream of the flipper bar in the rotating direction. The brush roller may be rotated about a center line extending along a vertical plane, the flipper bar being disposed near the vertical plane.

The brush unit may comprise an opening and a sheet or continuous web installed in the opening.

There is also provided a tray disposed beneath the cylinder cleaning brush unit. The tray comprises an opening through which the effluent is received in the tray. The tray further comprises a filter by which at least a portion of the opening is covered, the effluent being filtrated by the filter.

The filter may extend to the vicinity of a tangent which extends tangentially to the brush roller and the cylinder at the contact position.

The tray may further comprise a bottom in which an outlet port is formed, an additional tray being disposed under the outlet port so that the effluent can be discharged from the outlet port to be received in the additional tray.

The filter may be made of woven or nonwoven fabric, net or perforated film. The filter may comprise a sheet.

The filter may comprise a continuous web held by and fed from a holder. In this case, the tray may further comprise take up means for taking up the used filter. The tray may further comprise first and second end portions, the holder being disposed under the first end portion, the take up means being disposed in the second end portion. In addition, it is preferred that the brush unit can be moved toward and away from the cylinder, the tray including driven means driven in accordance with the movement of the brush unit to make the take up means take up the used filter. The tray may further comprise detecting means for detecting the decrease or exhaustion of the filter held by the holder.

The filter may comprise a sheet made of woven or nonwoven fabric, net or perforated film, the tray further comprising fixing means by which the filter is fixed to the opening.

The tray may further comprise an outlet port through which the effluent is discharged after filtrated by the filter. The tray may further comprise absorbent material for absorbing the effluent for disposal. The tray may further comprise solidification or gelatinization agent for solidifying or gelatinizing the effluent for disposal.

The filter may be received and supported by a receiver. The filter may comprise a perforated plate. The plate may include a surface having convex or concave portions. The plate may include a surface wave-shaped. The filter may further comprise fabric, net or perforated film by which the surface of the plate is covered. The filter may further comprise lubricant for lubricating the surface of the plate. The filter may include positioning means cooperating with the positioning means of the take up shaft to position the filter when attached. The filter may include fixing means cooperating with the fixing means of the tray.

There is also provided a cylinder cleaning apparatus including the brush unit which comprises the brush roller for cleaning the cylinder. The apparatus comprises an opening through which effluent is discharged from the brush unit, the effluent including the cleaning liquid and the impurities, and a filter disposed in the opening, the effluent being filtrated by the filter.

The opening may be formed in the brush unit, the filter being mounted on the brush unit to be disposed in the opening.

The apparatus may further comprise a tray disposed beneath the brush unit, the opening being formed in the tray, the filter being mounted on the tray to be disposed in the opening, the effluent being received in the tray after filtrated by the filter.

### BRIEF DESCRIPTION OF THE DRAWINGS

FIG. 1 is an explanatory view of a brush unit according to the invention.

FIG. 2 is an explanatory view of other brush unit according to the invention.

FIG. 3 is a side view of a preferred embodiment of the invention.

FIG. 4 is a perspective view of a filter according to the invention.

FIG. 5 is a perspective view of other filter according to the invention.

FIG. 6 is a perspective view of other filter according to the invention.

FIG. 7 is a side view of other embodiment of the invention.

FIG. 8 is a side view of other embodiment of the invention.

FIG. 9 is a perspective view of a tray according to the invention.

FIG. 10 is a sectional view taken along a line I-I of FIG. 9.

FIG. 11 is a plan view of the filter of FIG. 9.

FIG. 12 is a perspective view of other tray according to the invention.

FIG. 13 is a side view of other embodiment of the invention.

FIG. 14 is a side view of other embodiment of the invention,

FIG. 15 is a side view of other embodiment of the invention.

FIG. 16 is a perspective view of the positioning means of the take up shaft according to the invention.

FIG. 17 is a perspective view of the positioning means of the filter according to the invention.

FIG. 18 is an explanatory view of a detecting means for detecting the decrease or exhaustion of the filter according to the invention.

FIG. 19 is an elevational view of the filter of FIG. 18.

FIG. 20 is an explanatory view of other detecting means for detecting the decrease of exhaustion of the filter according to the invention.

FIG. 21 is a side view of adjustment means for a flipper bar according to the invention.

FIG. 22 is a sectional view taken along a line II-II of FIG. 21.

FIG. 23 is a side view of other adjustment means for the flipper bar according to the invention.

FIG. 24 is a side view of other embodiment of the invention.

FIG. 25 is a side view of other embodiment of the invention.

FIG. 26 is a side view of other embodiment of the invention.

FIG. 27 is a side view of a cylinder cleaning apparatus of prior art.

FIG. 28 is a perspective view of the apparatus of FIG. 27.

### DETAILED DESCRIPTION OF THE PREFERRED EMBODIMENT

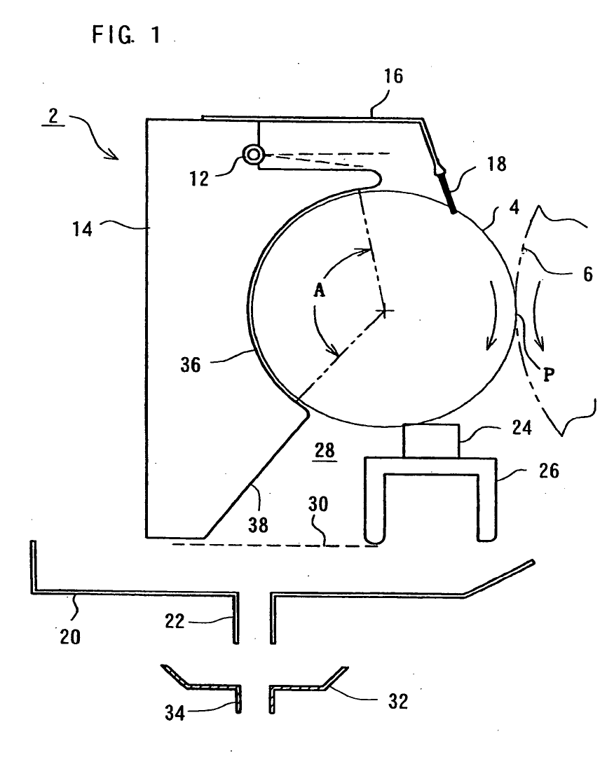

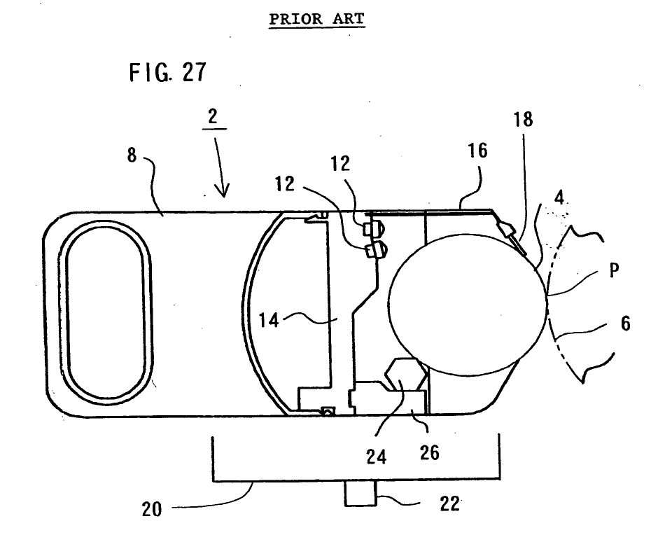

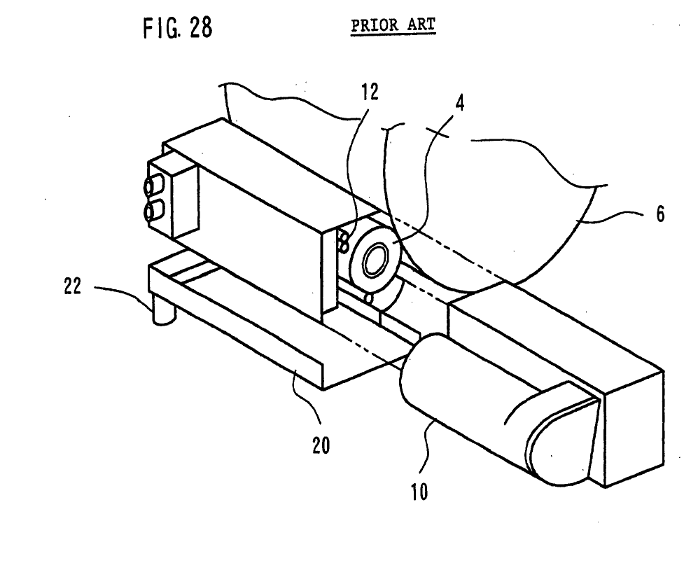

Referring now to the drawings, FIG. 1 illustrates a cylinder cleaning apparatus including a brush unit 2 which comprises a brush roller 4 for cleaning a cylinder 6 according to the invention. The brush roller 4 is disposed between and mounted on side frames for rotation to be brought into contact with the cylinder 6 at a contact position P, the brush roller 4 extending parallel to the cylinder 6, as in the case of the apparatus of FIG. 27. In addition, the brush roller 4 is rotated in a rotating direction to clean the cylinder 6. In the embodiment, the brush roller 4 is rotated clockwise in FIG. 1 by a drive such as a motor to clean the cylinder 6 which is rotated counterclockwise at a speed different from the brush roller 4, as also in the case of the apparatus of FIG. 27. It should therefore be recognized that the brush roller 4 and the cylinder 6 are rotated downwardly at the contact position P. The cylinder 6 includes an outer surface to which impurities are adhered, the impurities being removed from the outer surface by the brush roller 4 with cleaning liquid being supplied.

The brush roller 4 may be rotated reversely to clean the cylinder 6.

The brush unit 2 further includes a spray bar or nozzles 12 for spouting the cleaning liquid comprising solvent and water which are directed to the brush roller 4 and the cylinder 6 by a cover plate 16 and a hood 18, as also in the case of the apparatus of FIG. 27. In addition, a flipper bar 24 is disposed downstream of the contact position P in the rotating direction of the brush roller 4 and brought into contact with the brush roller 4. The flipper bar 24 is supported by a stay 26 disposed between and mounted on the side frames to extend longitudinally of the brush roller 4. The effluent is therefore flipped from the brush roller 4 by the flipper bar 24.

The brush unit 2 further includes an opening 28 formed therein. Effluent is discharged from the brush unit 2 through the opening 28, the effluent including the cleaning liquid and the impurities. The opening 28 is formed downstream of the flipper bar 24 in the rotating direction of the brush roller 4. The brush unit 2 further includes a filter 30 disposed and installed in the opening 28 so that the effluent can be filtrated by the filter 30. The filter 30 is made of a woven or nonwoven fabric, net or perforated film. The fabric should be composed of synthetic fibers, natural fibers, metal wires or the mixture thereof to be free of oil impregnation, oil absorbency, lipophilic, water impregnation, water absorbency and hydrophilic.

The apparatus further includes a tray 20 disposed beneath the brush unit 2 so that the effluent can be discharged from the brush unit 2 to be received in the tray 20, as also in the case of the apparatus of FIG. 27. The tray 20 includes a bottom in which an outlet port 22 is formed. An additional tray 32 is disposed under the outlet port 22 so that the effluent can be discharged from the outlet port 22 to be received in the additional tray 32. The additional tray 32 includes a bottom in which an outlet port 34 is formed. A drain pipe can therefore be connected to the outlet port 34 to drain the effluent into a receptacle from the additional tray 32 through the drain pipe.

Accordingly, in the apparatus, the effluent can be received in the tray 20 after filtrated by the filter 30. The effluent is then received in the additional tray 34 and directed into the drain pipe. As a result, no sludge can be grown from the effluent received in the tray 20 and the additional tray 34 after filtrated by the filter 30. It is therefore not required to clean the tray 20 and the additional tray 34 of sludge. In addition, no sludge can be grown from the effluent and adhered to and deposited on the inner surface of the drain pipe, the drain pipe being not clogged with sludge. It is therefore not required to clean the drain pipe of sludge. The operator is not forced to do dirty work taking labours and times. It is also not required to exchange the drain pipe for now one.

Furthermore, the apparatus includes a cover frame or cross frame 14 disposed opposite to the cylinder 6 with respect to the brush roller 4. The spray bar 12 is mounted on the cover frame 14 which is disposed between and mounted on the side frames to extend longitudinally of the brush roller 4, as in the case of the cross frame 14 of FIG. 27. In addition, the cover frame 14 includes a curved surface 36 extending along the periphery of the brush roller 4. The brush roller 4 is brought into contact with the curved surface 36 in an angular range A. The brush roller 4 can therefore be rotated in the rotating direction to clean the curved surface 36 of the cover frame 14 even if sludge will be grown from the effluent and adhered to the curved surface 36. The brush roller 4 may be close to the curved surface 36 in the angular range A to clean the curved surface 36. Accordingly, no sludge can be deposited on the curved surface 36. The operator is therefore not required to clean the curved surface 36 of sludge.

The cover frame 14 further includes an inclined surface 38 extending downwardly from the lower edge of the curved surface 36 to be inclined away from the cylinder 6 with respect to a vertical plane. The curved surface 36 and the inclined surface 38 are disposed downstream of the flipper bar 24. Sludge is therefore not adhered to and deposited on the inclined surface 38 but moved down along the inclined surface 38 to be dropped onto the filter 30 when the inclined surface 38 is splashed with the effluent flipped from the brush roller 4 by the flipper bar 24. The operator is not required to clean the inclined surface 38 of sludge.

The brush roller 4 is rotated about a center line extending along a vertical plane. The flipper bar 24 is disposed near the vertical plane so that the effluent can be flipped from the brush roller 4 by the flipper bar 24 to be directed into the opening 28.

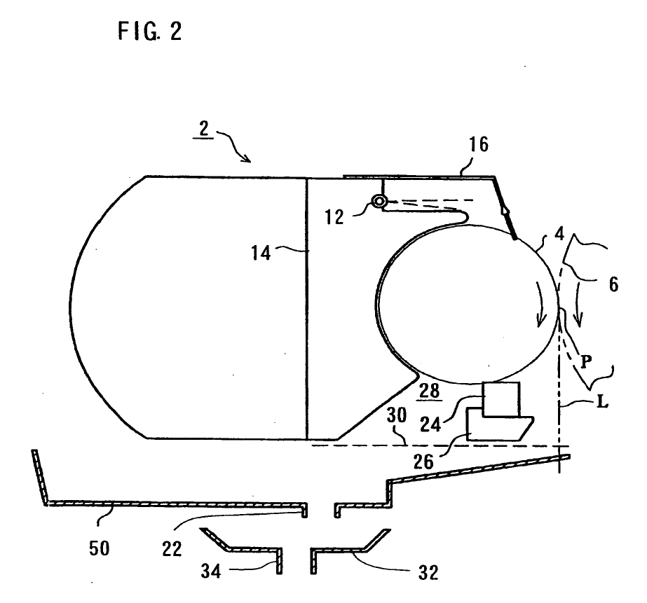

The filter 30 may be installed in the opening 28 to extend the vicinity of a tangent L which extends tangentially to the brush roller 4 and the cylinder 6 at the contact position P, as shown in FIG. 2. In this case, the effluent can be filtrated by the filter 30 even if flipped from the brush roller 4 brought into contact with the cylinder at the contact position P to be directed to the vicinity of the tangent L. The effluent is then received in the tray 20 after filtrated by the filter 30.

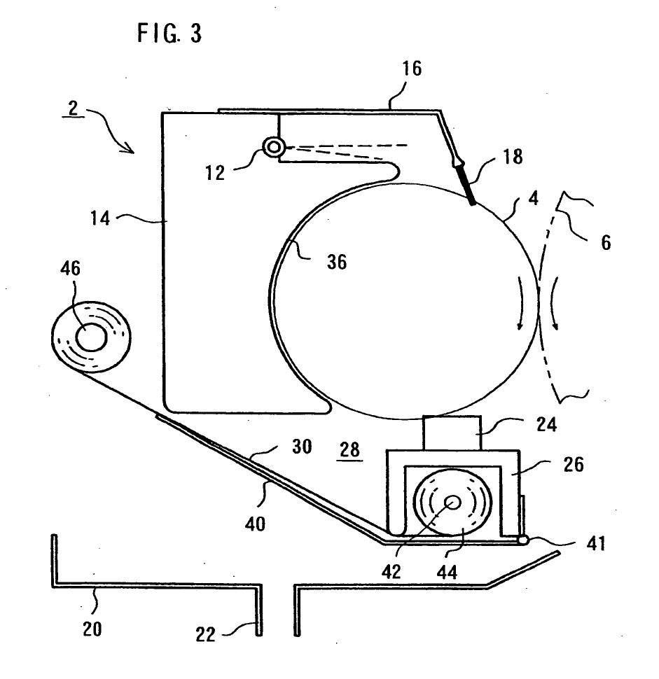

In a preferred embodiment shown in FIG. 3, the filter 30 is received and supported by a receiver 40 which comprises a perforated plate mounted on a pivotal member 41 for pivotally movement thereabout. The receiver 40 may comprise comb-shaped member or net. The effluent is discharged from the brush unit 2 through the opening 28 which is formed between the flipper bar 24, the stay 26 and the cover frame 14, to be filtrated by the filter 30. The effluent then passes through the receiver 40 after filtrated, to be received in the tray 20 and discharged from the outlet port 22. The filter 30 and the receiver 40 extend toward the stay 26 to be inclined downwardly with respect to a horizontal plane to keep the cover frame 14 being not splashed with the effluent flipped from the brush roller 4 by the flipper bar 24.

In the embodiment, the filter 30 comprises a continuous web held by and fed from a holder which comprises a core 42 about which the filter 30 is wound so that a supply roll 44 can be formed by the filter 30, the core 42 being disposed between and mounted on the side frames for rotation. The filter 30 may be arranged to be held by and fed from a holder other than the core 42. The stay 26 has a reversed U-shaped channel cross section in which an inside space is formed, the filter 30 being held by the holder to be accommodated in the inside space. The brush unit 2 further includes a take up means comprising a take up shaft 46 disposed at the back of the cover frame 14 for taking up the used filter 30. The take up shaft 46 may be rotated manually or automatically to take up the used filter 30.

The filter 30 may comprise a sheet.

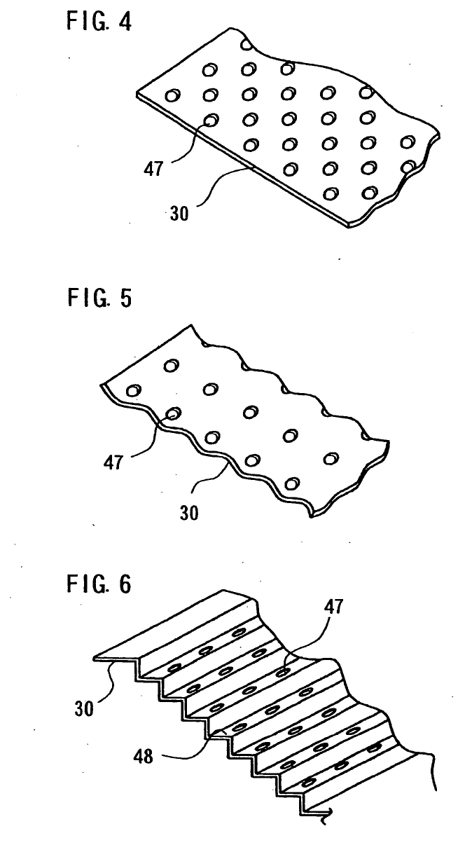

The filter 30 may comprise a perforated plate including perforations 47, as shown in FIG. 4. The plate 30 may includes a surface wave-shaped having valley portions in which the perforations 47 are formed, as shown in FIG. 5. The plate 30 may take the form of stairs having horizontal steps 48 in which the perforations 47 are formed, as shown in FIG. 6. The filter 30 may comprise fabric, net or perforated film by which the surface of the plate is covered. In this case, the filter 30 may further comprise lubricant for lubricating the surface of the plate to prevent the fabric, net or perforated film from being adhered to the plate. It should be recognized that the adhesion is harmful to the filtration. In addition, the fabric, net or perforated film can be slidingly moved along the plate by the lubricant.

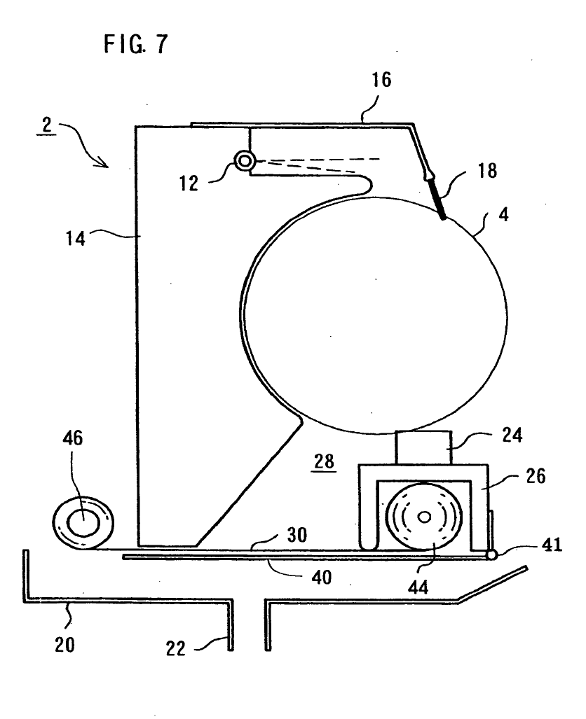

In other embodiment shown in FIG. 7, the filter 30 and the receiver 40 extend horizontally between the lower end portions of the stay 26 and the cover frame 14 which includes the curved surface 36 and the inclined surface 38, as in the case of the apparatus of FIG. 1.

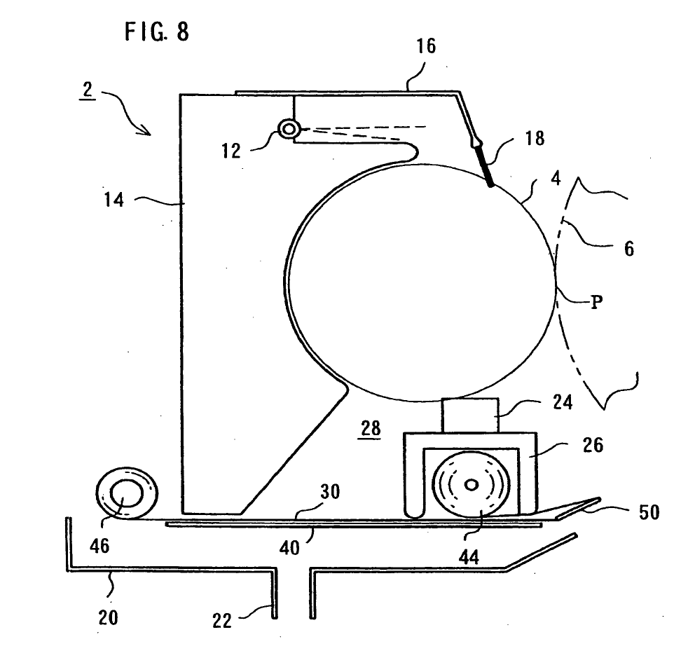

In other embodiment shown in FIG. 8, the filter 30 is directed to a guide member 50 from the supply roll 44. The guide member 50 is mounted on the side frames to extend parallel to the stay 26. The filter 30 is engaged with the guide member 50 to be turn down to the lower side from the upper side thereof. The filter 30 is then directed to the take up shaft 46 from the guide member 50 through a clearance formed between the stay 26 and the receiver 40. The guide member 50 is disposed at the vicinity of the tangent L which extends tangentially to the brush roller 4 and the cylinder 6 at the contact position P so that the filter 30 can be installed in the opening 28 to extend to the vicinity of the tangent L, as in the case of the apparatus of FIG. 2.

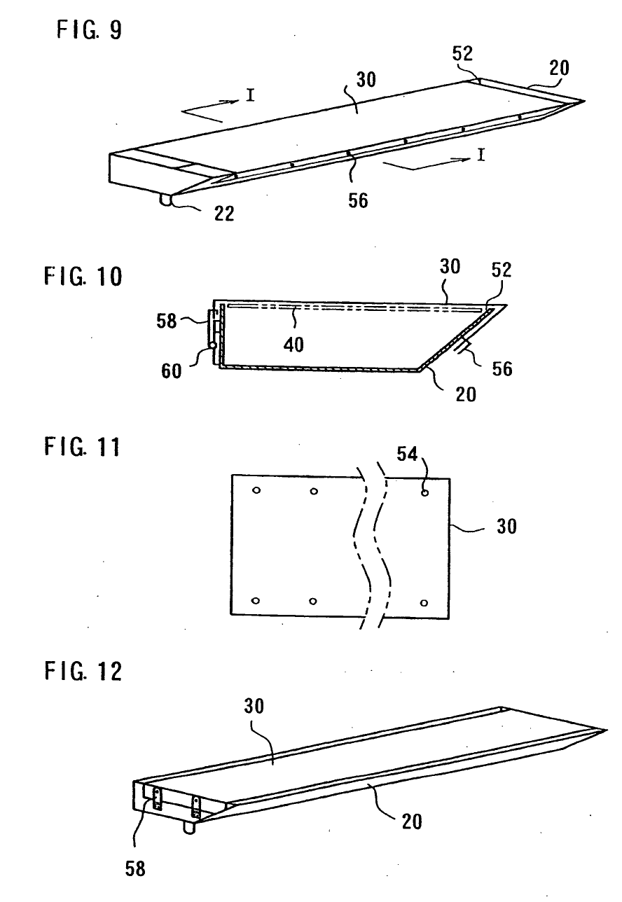

In other embodiment shown in FIG. 9, the apparatus includes the tray 20 which includes an opening 52 through which the effluent is discharged from the brush unit 2 to be received in the tray 20. The tray 20 further includes the filter 30 by which at least a portion of the opening 52 is covered, the effluent being filtrated by the filter 30. The filter 30 comprises a sheet which includes holes 54 formed therein, as shown in FIG. 11. The tray 20 further includes Hooks 56 and 58 mounted on the side surfaces thereof and engaged with the holes 54 so that the filter 30 can be mounted on the tray 20 to be disposed in the opening 52. The hooks 56 are fixed to the tray 20. The hooks 58 are mounted on the tray 20 by hinge means 60 for pivotally movement about the hinge means 60. The tray 20 may include the receiver 40 mounted thereon for removal to be disposed in the opening 52 so that the filter 30 can be received and supported by the receiver 40.

In the embodiment, the effluent is received in the tray 20 after filtrated by the filter 30. Accordingly, no sludge can be grown from the effluent received in the tray 20. It is therefore not required to clean the tray 20 of sludge. The filter 30 can be removed from the tray 20 for disposal at intervals by the hooks 58 pivotally moved about the hinge means 60 to be disengaged from the holes 54, the hooks 56 being then disengaged from the holes 56.

The tray 20 may include the hooks 56 and 58 which are mounted not on the side surfaces but the end surfaces thereof and engaged with the holes 54 so that the filter 30 can be mounted on the tray 20 to be disposed in the opening 52, as shown in FIG. 12.

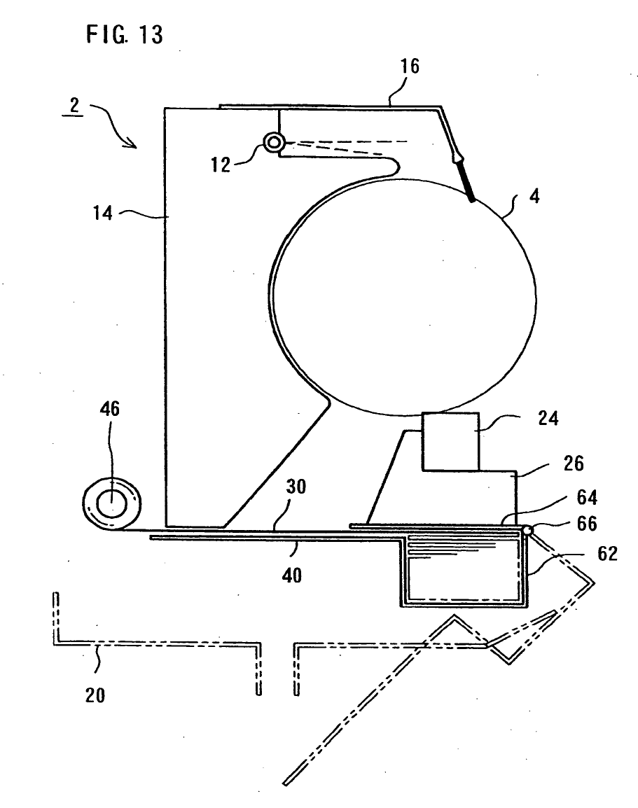

In other embodiment shown in FIG. 13, the filter 30 comprises a continuous web held by and fed from a holder which comprises a case 62 mounted on an upper plate 64 by hinge means 66 for pivotal movement about the hinge means 66, the upper plate 64 being mounted on the lower surface of the stay 26. The filter 30 is folded and received in the case 62 and directed to the take up shaft 46 along the receiver 40 which is formed integrally with the case 62. The receiver 40 extends from the case 62 to reach a position under the cover frame 14. The case 62 is pivotally moved about the hinge means 66 when the filter 30 is received in the case 62, as shown by broken line.

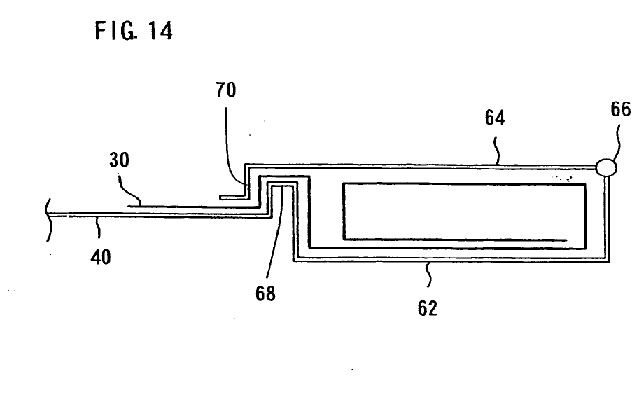

In other embodiment shown in FIG. 14, a standing portion 68 is formed between the case 62 and the receiver 40. The upper plate 64 extends across the standing portion 68 and includes an end portion 70 which is bended downwardly along the standing portion 68 and then horizontally along the receiver 40 so that a passage can be formed between the upper plate 64 and the standing portion 68. The filter 30 is directed along the receiver 40 from the case 62 through the passage. The end portion 70 cooperates with the standing portion 68 to prevent the effluent from entering the case 62.

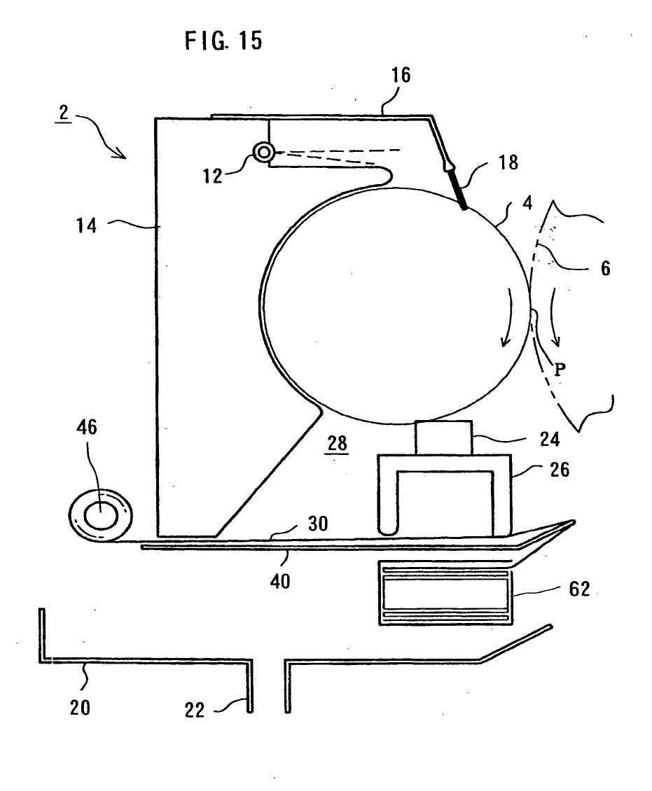

In other embodiment shown in FIG. 15, the filter 30 is directed from the case 62 which is disposed under the receiver 40. The receiver 40 includes an edge with which the filter 30 is engaged to be turn up to the upper side from the lower side of the receiver 40. The filter 30 is then directed along the receiver 40. The filter 30 can be received in the case 62 through a lid which is not shown but formed in one wall of the case 62.

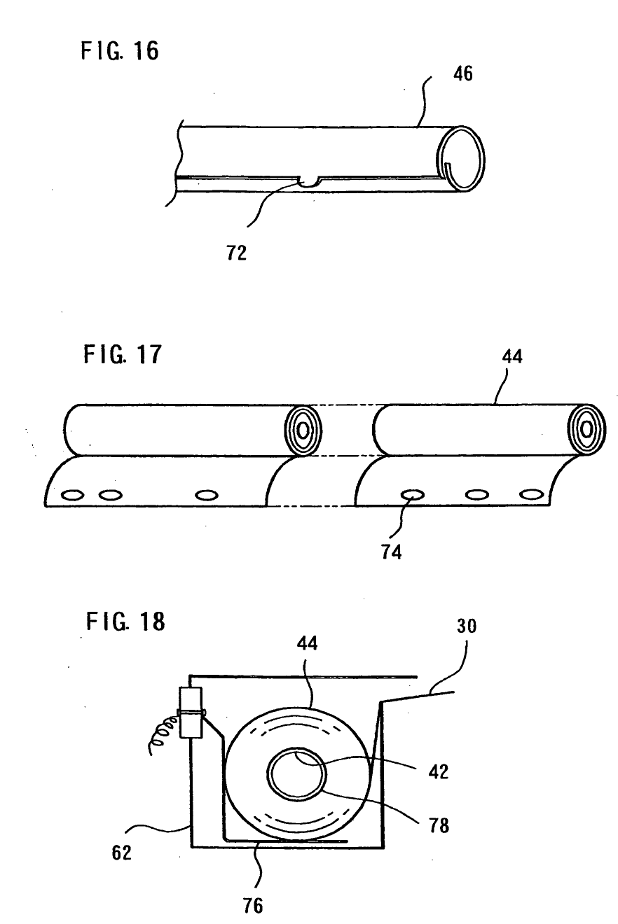

As to the take up means comprising the take up shaft 46 for taking up the used filter 30, positioning means should be formed on the take up shaft 46 for positioning the filter 30 when attached to the take up shaft 46. The positioning means may comprise at least one of the protrusions 72 formed on the take up shaft 46, as shown in FIG. 16. The filter 30 should include positioning means cooperating with the protrusions 72 of the take up shaft 46 to position the filter 30 when attached. For example, the filter 30 may include at least one of holes 74 formed therein, as shown in FIG. 17, so that the protrusions 72 can be engaged with the holes 74 to position the filter 30 when attached.

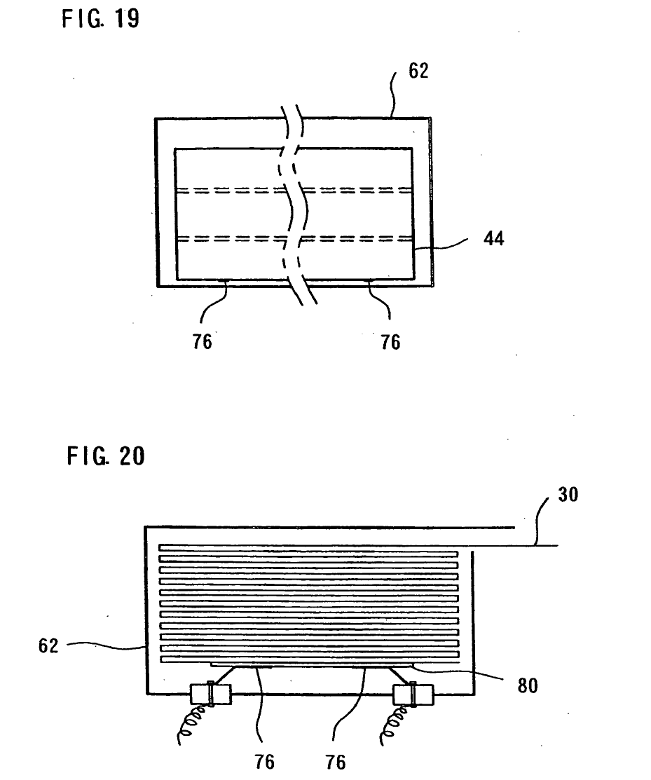

The brush unit 2 should include detecting means for detecting the decrease or exhaustion of the filter 30 held by the holder. The holder may comprise the case 62 in which the supply roll 44 is received, as shown in FIG. 18. The detecting means comprises a pair of fingers 76 formed of conductor and disposed in the case 62, as shown in FIG. 19, so that the supply roll 44 can be put on the fingers 76. The supply roll 44 comprises the filter 30 wound about the core 42. It should therefore be recognized that the supply roll 44 or filter 30 is held by the fingers 76 and the case 62. The fingers 76 are connected to an electrical circuit. In addition, the core 42 includes an outer surface 78 formed of conductor such as aluminum so that the fingers 76 can be connected to each other by the core 42 when the filter 30 is decreased or exhausted in the case 62 to detect the decrease or exhaustion of the filter 30 for electrical indication such as warning.

The fingers 76 may be disposed in the case 62 in which the filter 30 is folded and received, as shown in FIG. 20. The fingers 76 are connected to each other by a membranous member 80 which is formed of conductor such as aluminum and fixed to the end portion of the filter 30. In this case, the membranous member 80 is lifted and separated from the fingers 76 by the filter 30 when the filter 30 is decreased or exhausted in the case 62 so that the fingers 76 are disconnected from each other to detect the decrease or exhaustion of the filter 30 for electrical indication such as warning.

The detecting means may comprise an optical sensor disposed in the case 62 to detect a light reflected from the filter 30. This can also detect the decrease or exhaustion of the filter 30.

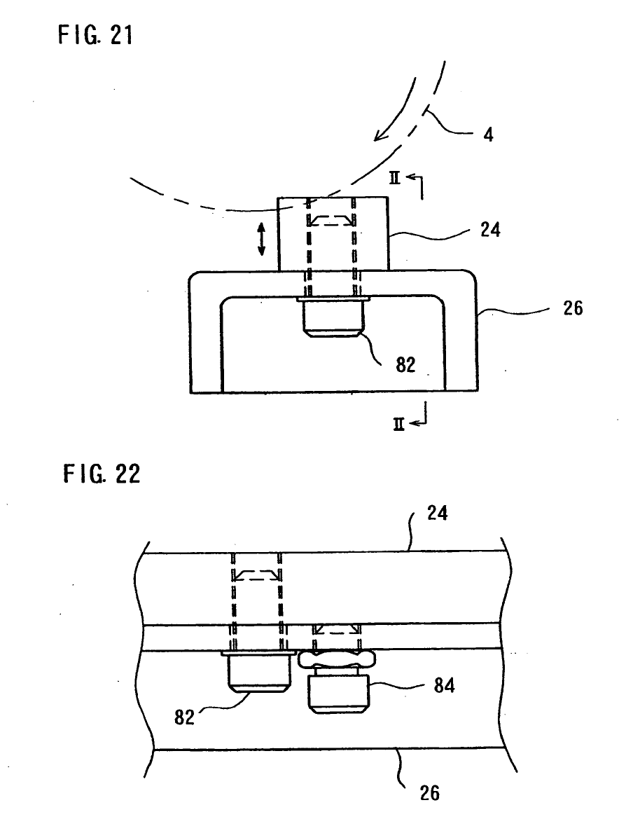

The brush unit 2 should include adjustment means by which the flipper bar 24 is moved for adjustment of position. The adjustment means may comprise bolts 82 and 84, as shown in FIG. 21 and FIG. 22, the bolts 82 passing through the stay 26 to be threadedly engaged with the flipper bar 24. The bolts 84 are threadedly engaged with the stay 26 to be engaged with the under surface of the flipper bar 24 so that the flipper bar 24 can be moved upwardly or downwardly by the bolts 82 and 84 for adjustment of position. The effluent can therefore be flipped toward the opening 28 from the brush roller 4 by the flipper bar 24 effectively. It should therefore be recognized that the flipper bar 24 is supported by the stay 26 for movement, the stay 26 including the adjustment means 82 and 84 mounted thereon. The stay 26 has a reversed U-shaped channel or L-shaped angle cross section in which an inside space is formed, the adjustment means 82 and 84 being accommodated in the inside space.

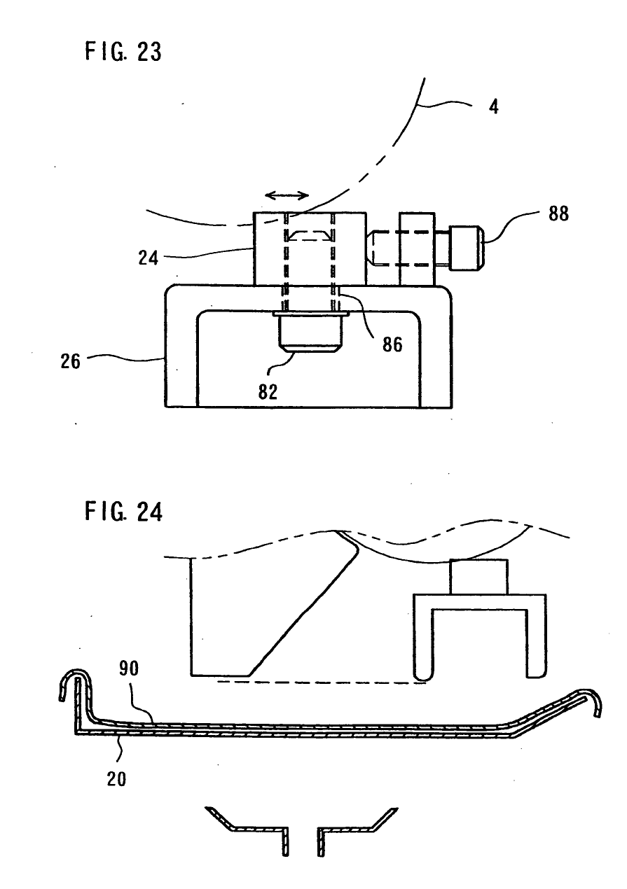

The stay 26 may include elongated slots 86 formed therein, as shown in FIG. 23, the bolts 82 passing through the slots 86 to be threadedly engaged with the flipper bar 24. In the embodiment, the adjustment mean further includes bolts 88 by which the flipper bar 24 is moved along the slots 86 for adjustment of position.

The tray 20 may include absorbent material 90 comprising a sheet laid along the bottom of the tray 20 for absorbing the effluent for disposal, as shown in FIG. 24. The tray 20 may include solidification or gelatinization agent for solidifying or gelatinizing the effluent for disposal.

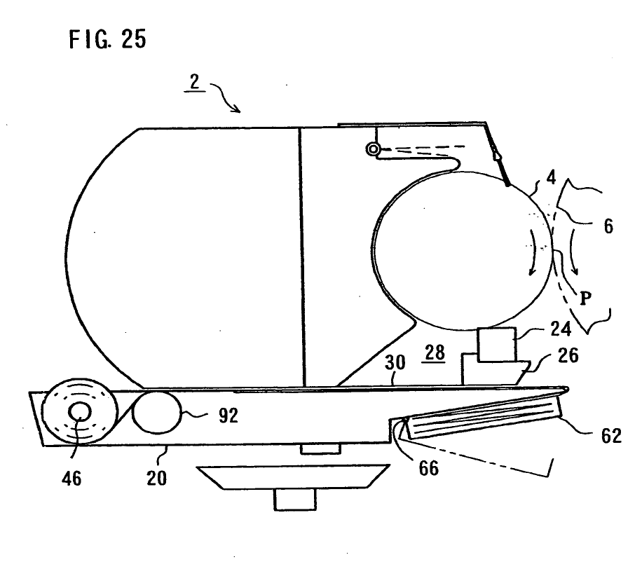

In other embodiment shown in FIG. 25, the tray 20 includes the opening through which the effluent is received in the tray 20. The tray 20 further includes the filter 30 by which at least a portion of the opening is covered, the effluent being filtrated by the filter 30. The filter 30 comprises the continuous web which is held by the holder comprising the case 62 in which the filter 30 is folded and received. The tray 20 further includes the take up means comprising the take up shaft 46 for taking up the used filter 30. In addition, the tray 20 includes first and second end portions, the case 62 being disposed under and mounted on the first end portion which is disposed under the brush roller 4 and the flipper bar 24. The take up shaft 46 is disposed in the second end portion of the tray 20. The filter 30 is fed from the case 62 and engaged with the edge of the tray 20 to be turn up to the upper side from the lower side of the tray 20. The filter 30 is then directed to the take up shaft 46 through a guide roller or bar 92 which is also disposed in the tray 20. The filter 30 therefore extends to the vicinity of the tangent L which extends tangentially to the brush roller 4 and the cylinder 6 at the contact position P.

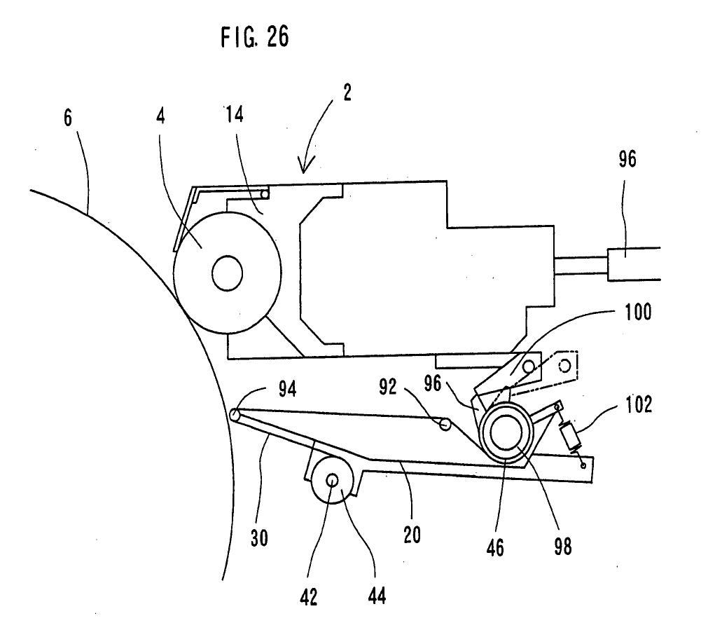

In other embodiment shown in FIG. 26, the filter 30 is wound about the core 42 so that the supply roll 44 can be formed by the filter 30. The core 42 and the supply roll 44 are disposed under the first end portion of the tray 20 to keep the supply roll 44 from being stained with the effluent. In addition, the core 42 and the supply roll 44 are mounted on the first end portion of the tray 20 for rotation so that the filter 30 can be fed from the supply roll 44 and engaged with a guide roller or bar 94 which is mounted on the edge of the tray 20. The filter 30 is then directed to the take up shaft 46 through the guide roller or bar 92. The take up shaft 46 is disposed in the second end portion of the tray 20 and mounted on the side walls of the tray 20 for rotation.

In the embodiment of FIG. 26, the apparatus includes drive means 96 comprising an air or hydraulic cylinder which is connected to the brush unit 2 so that the brush unit 2 can be moved toward and away from the cylinder 6. The tray 20 includes driven means driven in accordance with the movement of the brush unit 2 to make the take up shaft 46 take up the used filter 30. The driven means comprises a lever 96 connected to the take up shaft 46 through a one way clutch 98. The brush unit 2 includes a pusher 100 mounted thereon so that the lever 96 can be engaged with and pushed by the pusher 100 when the brush unit 2 is moved toward the cylinder 6. The take up shaft 46 is therefore rotated by the lever 96 and the one way clutch 98 to take up the used filter 46. The lever 96 is then returned by a return spring 102, the take up shaft 46 being prevented from reversely rotated by the one way clutch 98, when the brush unit 2 is moved away from the cylinder 6.

The tray 20 may include the detecting means shown in FIG. 18 or FIG. 20 for detecting the decrease or exhaustion of the filter 30 held by the holder.

The brush unit 2 may be arranged to clean the cylinder 6 without utilizing the cleaning liquid. The cylinder 6 includes the outer surface to which impurities are adhered. In this case, a sheet or continuous web may be installed in an opening so that the impurities can be removed from the outer surface by the brush roller 4 to be directed into the opening and received by the sheet or continuous web, according to the invention.

1. A cylinder cleaning brush unit including a brush roller for cleaning a cylinder, said cylinder including an outer surface to which impurities are adhered, said impurities being removed from said outer surface by said brush roller with cleaning liquid being supplied, said brush unit comprising:
an opening through which effluent is discharged from said brush unit, said effluent including said cleaning liquid and said impurities; and
a filter installed in said opening, said effluent being filtrated by said filter.

2-18. (canceled)

19. A cylinder cleaning brush unit including a brush roller for cleaning a cylinder, said cylinder including an outer surface to which impurities are adhered, said impurities being removed from said outer surface by said brush roller with cleaning liquid being supplied, said brush unit comprising:
a cover frame disposed opposite to said cylinder with respect to said brush roller, said cover frame including a curved surface extending along the periphery of said brush roller, and an inclined surface extending downwardly from the lower edge of said curved surface to be inclined away from said cylinder with respect to a vertical plane.

20. The brush unit as set forth in claim 19 wherein said brush roller is brought into contact with said curved surface in an angular range.

21. The brush unit as set forth in claim 19 wherein said brush roller is close to said curved surface in an angular range.

22. The brush unit as set forth in claim 19 wherein said brush roller is brought into contact with said cylinder at a contact position and rotated in a rotating direction to clean said cylinder, said brush unit further comprising a flipper bar disposed downstream of said contact position in said rotating direction and brought into contact with said brush roller, said curved surface and said inclined surface being disposed downstream of said flipper bar in said rotating direction.

23. The brush unit as set forth in claim 22 wherein said brush roller is rotated about a center line extending along a vertical plane, said flipper bar being disposed near said vertical plane.

24-55. (canceled)
